(19) United States
(12) Patent Application Publication
(10) Pub. No.: US 2006/0259964 A1
(43) Pub. Date: Nov. 16, 2006

(54) Applying local machine restrictions on a per-user basis

(75) Inventors: Jose F. Maldonado, Seattle, WA (US); Derick A. Campbell, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/336,722

(22) Filed: Jan. 20, 2006

Related U.S. Application Data
(60) Provisional application No. 60/679,441, filed on May 10, 2005.

(51) Int. Cl. G06F 12/14

(52) U.S. Cl. 726/16

(57) ABSTRACT

The ability to apply local machine restrictions on a per-user basis on machines that do not use a directory service is provided. A script that loads a user registry hive through a user interface is provided. The user interface provides a means for an authorized user to apply machine restrictions to a plurality of users. Through interaction with the user interface the registry hive is modified and applied to the appropriate user profile.

### CROSS-REFERENCE TO RELATED APPLICATIONS

This application claims the benefit of U.S. Provisional Application Ser. No. 60/679,441, filed May 10, 2005, entitled “SYSTEM AND METHOD FOR APPLYING LOCAL MACHINE RESTRICTIONS ON A PER-USER BASIS.” The entirety of this application is incorporated herein by reference.

### BACKGROUND

Computers and computer systems can be utilized in environments such as libraries, schools, community centers, etc. where more than one user has access to the computer. Some of these users may be trustworthy while others might use the system in an untrustworthy manner. For example, an untrustworthy user may maliciously alter software and/or programs on the computer or may add additional, unnecessary, and/or potentially harmful software and/or programs.

Administrators and other users of a computer system in distributed networking environments can utilize an infrastructure to implement and mange multiple local machine restrictions. A type of such infrastructure is an Active Directory, which is a directory service that provides centrally administered authentication, application service, and/or user registration services for distributed networking environments. With such a conventional directory service, it is possible to provide differentiated local machine restrictions and policies for multiple machine users.

While it is valuable to configure computers with user accounts that have different and/or varying restrictions that limit the functionality provided to users who have logged onto the computer, in some situations a conventional directory service is not available. This unavailability can be due to lack of resources or adequate knowledge to implement and operate such an infrastructure. Additionally, there are some environments in which implementing a directory service is not economically feasible, such as in the case of schools or libraries, for example.

Without a directory service infrastructure to support multiple sets of user restrictions, a single set of local restrictions grouped in a single local policy is applied to all users of a computer, regardless of the role of such user. Therefore, computer administrative accounts have the same local policy as the other accounts of the computer. This often makes computers that rely on a local policy to provide specific user restrictions difficult to manage. Therefore, there is a need to provide computer administrators the ability to configure multiple local accounts with different sets of restrictions customized specifically on a user-by-user or user group basis.

### SUMMARY

The following presents a simplified summary of one or more embodiments in order to provide a basic understanding of some aspects of such embodiments. This summary is not an extensive overview of the one or more embodiments, and is intended to neither identify key or critical elements nor delineate the scope of such embodiments. Its sole purpose is to present some concepts of the described embodiments in a simplified form as a prelude to the more detailed description that is presented later.

Embodiments describe a method and/or system for applying per-user machine restrictions on a machine that does not use a directory service, although the machine may be configured to support such a directory service. An authorized user is provided the capability of updating a user profile with a restriction modification through an interactive user interface. The user interface provides a simple and efficient way for the authorized user to modify a registry hive on a per-user basis.

According to another aspect, the systems and/or methods provide an authorized user the ability to apply machine restrictions on a per-user basis through automation of one or more settings associated with a user registry hive. Provided is an administrator tool that includes restrictions settings and optional settings that can be applied to a user profile.

To the accomplishment of the foregoing and related ends, one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system for applying local machine restrictions on a per-user basis.

FIG. 2 illustrates a system that facilitates setting and/or modification of user restrictions on a local machine.

FIG. 3 illustrates a system that facilitates modifying or restricting user settings on a local machine through a registry hive.

FIG. 4 illustrates an exemplary user interface that facilitates configuration of machine restrictions.

FIG. 5 illustrates a system with functionality of a single local group policy that does not employ the disclosed techniques of applying local machine restrictions on a user-by-user basis.

FIG. 6 illustrates a system that employs multiple local user accounts with different user restrictions according to the disclosed techniques.

FIG. 7 illustrates a flow chart of a methodology for configuring, modifying and applying local machine restrictions.

FIG. 8 illustrates a block diagram of a computer operable to execute the disclosed embodiments.

FIG. 9 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

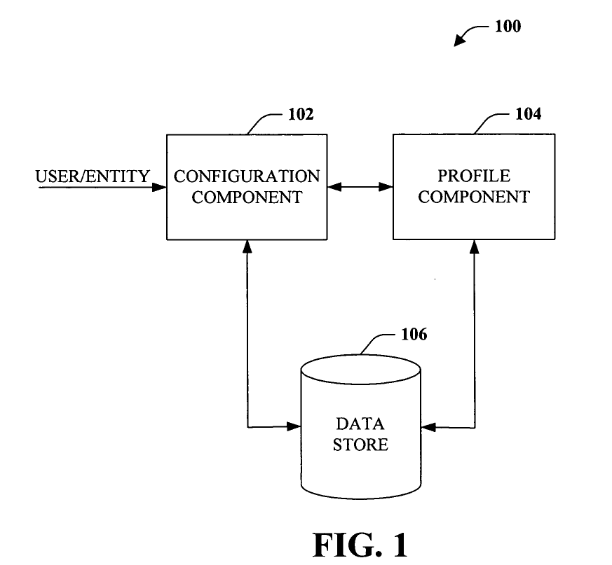

Referring initially to FIG. 1, illustrated is system 100 for applying local machine restrictions on a per-user basis. A per-user basis can apply to a specific user or it can apply to a plurality of users and/or groups. System 100 includes a configuration component 102 and a profile component 104 that interface with each other and with a data store 106. Configuration component 102 is configured to receive an input from a user and/or entity (e.g., the Internet, another system, a computer, . . . ), hereinafter referred to as user. The user input can be a request to modify and/or set user restrictions on a machine. It is to be understood that the user can be an administrator and/or another user having the appropriate authorization level to modify, create, delete, etc. machine restrictions. The machine restrictions can be policies, allowed actions, restricted actions, or other modifications that restrict or inhibit a user's ability to access, modify, or change a plurality of parameters of the machine. The parameters can include start menu programs, general operating system, Internet applications, word processing, software, etc. It is to be appreciated that the local machine can interface with a central server (e.g., file server).

The configuration component 102 interfaces with the profile component 104 to apply the defined modifications and/or set the restrictions. It should be appreciated that the modifications and/or restrictions are applied on a per-user basis. For example, in a library setting users can be broadly defined as “patrons” and/or “librarians.” The modifications and/or restrictions applied to patrons might be more limiting or restrictive than those applied to librarians. In essence, any patron of the library might have the ability to view the library catalog and access the Internet, but might not have the ability to modify Internet settings or other features of the machine, such as start menu capabilities. The user group “librarians” might have unlimited access to the machine configuration and when such user (librarian) logs onto the machine, the unlimited access is available for that user.

The configuration component 102 and/or user profile component 104 can receive and/or send information to a data store 106 associated with a local machine, for example. The data store 106 can retain modifications and/or restrictions for each classification of users and apply such settings upon machine start-up and/or logon. The data store 106 can also retain a registry hive and/or other data associated with a user or group of users. Moreover, the data store 106 can be memory and/or some other medium that can store information. By way of illustration, and not limitation, the data store 106 can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

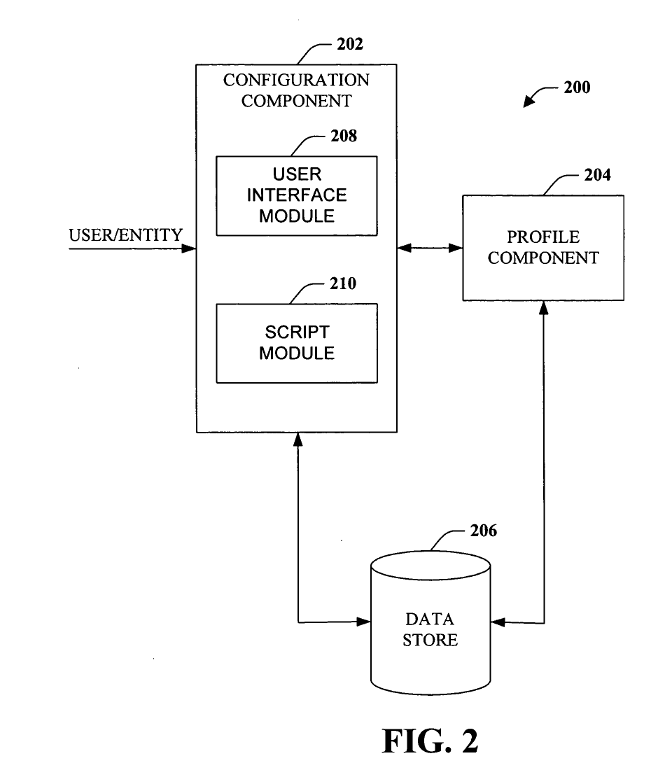

FIG. 2 illustrates a system 200 that facilitates setting and/or modifying user restrictions on a local machine. The user restrictions can apply to a plurality of parameters of a local machine and to one user or a plurality of users. For example, restrictions can be applied to start menu options, general operating system, Internet Explorer, word processing (e.g., Word, Excel, Access, . . . ), and/or other software and programs. Additional and/or optional restrictions can also be set and/or modified. The plurality of users refers to a group of users. For example, in a school setting the users can be divided into groups such as “Latin students,” “computer science students,” “English students,” with each group of students having different restrictions applied when the student logs onto a local machine. In addition, a group of users can be “teachers,” “librarians,” etc. These groups of users can have unlimited access to the various operations of the machine. The users can be distinguished automatically by the machine through utilization of a user name and/or password.

The configuration component 202 can provide various types of user interfaces to facilitate an administrator and/or authorized user to apply user restrictions in an efficient manner. Rather than requiring a user to find and manually apply hundreds of restrictions or settings, the configuration component 202 automates the setting of user restrictions. For example, the user can interact with the profile component 204 by entering the information into an edit control associated with the user interface module 208. It is to be appreciated that the user interface module 208 provides a user with an easy to use format.

The user interface module 208 interfaces with a script module 210 that can facilitate applying scripts to a local registry hive. Scripts that can load the registry hive (e.g., NTUser.DAT file) for an existing local user account can be provided. Registry settings that correspond to user restrictions that are traditionally configured by a local group policy object can be modified to implement user restrictions that only affect the specified user on machines.

A hive is a group of keys, subkeys, and values in a registry that has a set of supporting files containing backups of its data. A user's registry hive contains specific registry information pertaining to a user's application settings, desktop, environment, network connections, and/or printers. The script to load a user's registry can be a function or routine and in the following exemplary function is referred to as LoadUser:

```
Function LoadUser (sUser)
  Dim sProfilePath
  LoadUser = False
  sProfilePath = “ “
  sProfilePath = GetProfilepath (sUser)
  If sProfilePath <> “” Then
    OShell.Run “REG LOAD HKEY_USERS\SSW “ & Chr (34) &
sProfilePath & “\ntuser.dat” & Chr(34), 0, True
    LoadUser = True
  End If
End Function
```

In the above function, “sprofilepath=GetProfilePath (sUser)” references to the HKLM part of the registry and returns the path to the user profile for sUser. For example, this can be C:Documents and SettingsPublic. If the statement If sProfilePath <> “” is true, then the REG command is utilized to load the user's registry hive. The script file information can be retained in the data store 206 or in the profile component 204.

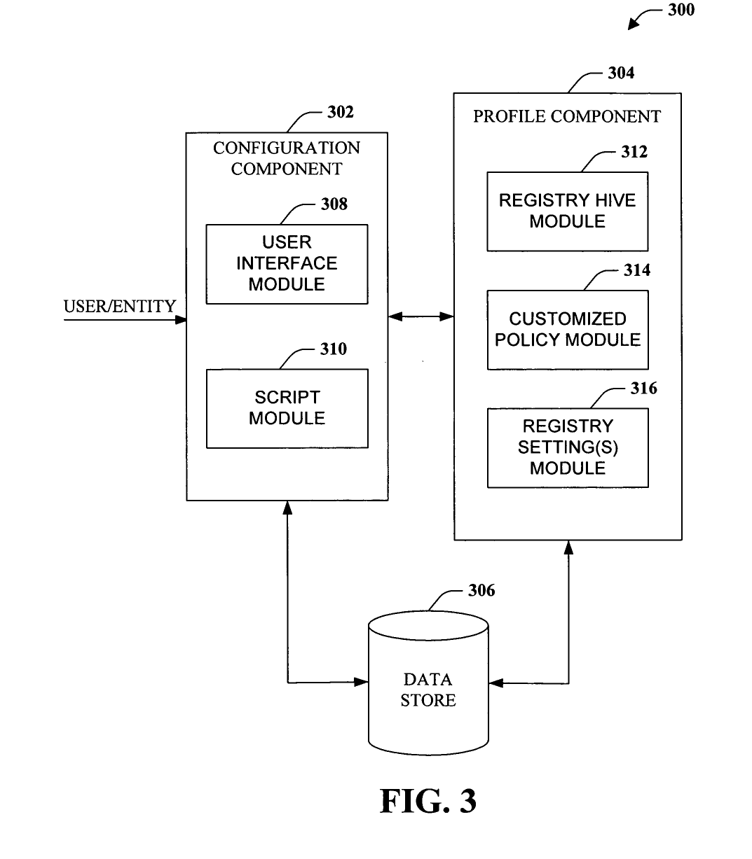

FIG. 3 illustrates a system 300 that facilitates modifying and/or restricting user settings on a local machine through a registry hive. System includes configuration component 302 that receives an input from a user and/or entity through a user interface module 308 and a script module 310 that can load the registry hive for the existing local user account. The configuration component interfaces with a profile component 304 to update the existing local user account and apply modifications or restrictions to user settings.

The profile component 304 can include a registry hive module 312, a customized policy module 314, and a registry settings module 316. The registry hive module 312 maintains information associated with a user account and/or obtains the information from a data store 306. Generally, when a machine is started or during the setup phase of a boot process, data from supporting files in the registry hive is automatically retrieved and applied to the current user. When the computer is shut down, the operating system can automatically write the hive data to the supporting files. In such a manner, when the user logs onto the system, the registry hive module 312 and supporting files are loaded onto the operating system, allowing the user to perform predefined specific functions.

The customized policy module 314 interfaces with both the registry hive module 312 and the registry setting module 316. Through an interaction with the configuration component 302, various policies as it relates to a plurality of parameters of the operating system are applied to the registry hive module 312 of a specified user. For example, policies can be applied that relate to word processing applications and/or start menu applications. Other policies can be applied that include session timers that automatically log off a user after a specified time period or drives to which the user can gain access or for which the user access is restricted, for example.

The registry setting(s) module 316 is configured to apply the registry setting to the registry hive of the user through interaction with the registry hive module 312. When the user starts the machine, the registry setting(s) module 316 applies the modified registry hive to the logged on user according to the predefined criteria input by the authorized user and/or entity into the configuration component 302. The information can be stored in the registry setting(s) module 316 and/or in a data store 306 for later retrieval.

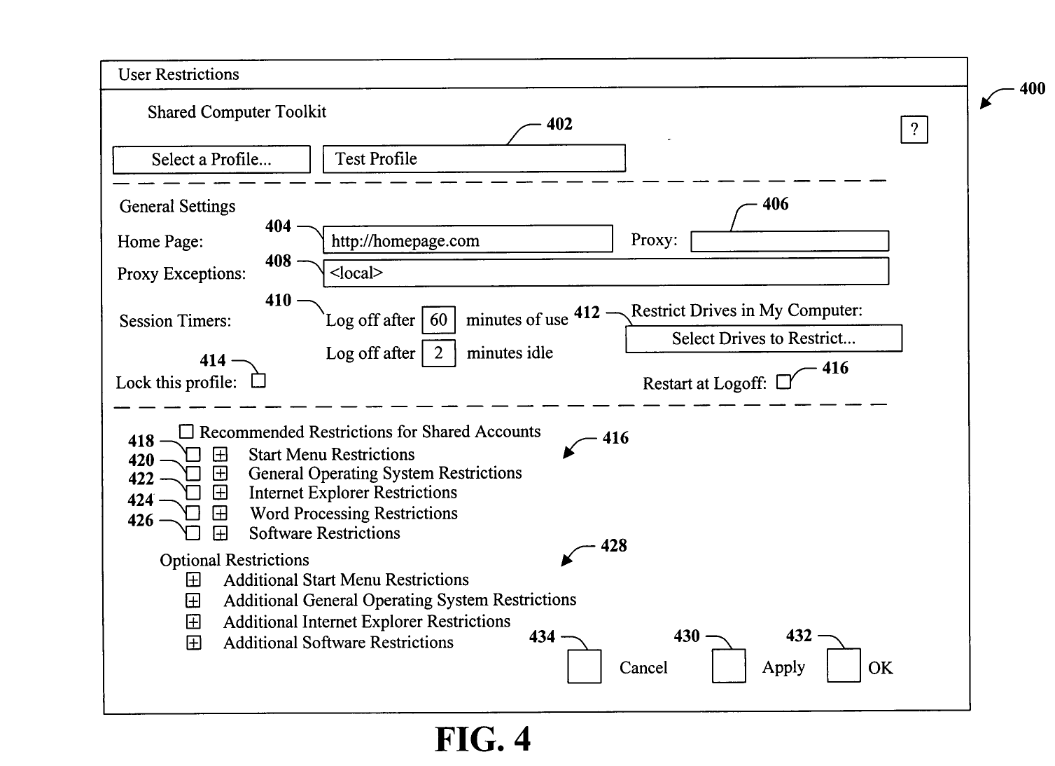

With reference now to FIG. 4, illustrated is an exemplary user interface 400 that facilitates configuration of machine restrictions on a per-user basis. An administrator and/or authorized user can interact with the user interface 402 though a configuration component, for example, that can provide a graphical user interface (GUI), a command line interface, and the like. For example, a GUI can be rendered that provides a user with a region or means to load, import, read, etc. desired actions and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation of such information such as vertical and/or horizontal scroll bars for navigation and toolbar buttons to determine whether a region will be viewable can be employed.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate information conveyance. However, it is to be appreciated that the subject disclosure is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels. It is to be appreciated that the user interface provides an administrator or other authorized user a simple and efficient manner of applying restrictions.

The user interface 400 can include a profile selection 402 that provides a selection of a profile that represents an arbitrary name of a user or user group to which the restrictions should be applied. Such a naming convention can be any name desired and should be representative of the group for convenience and reference. Profile(s) can be added and/or deleted through interaction with the user interface 400.

A general settings section of the user interface 400 can include a home page 404 selection, which can be, for example, the home page of the particular organization (e.g., library, school, . . . ) where the local machine is located. The home page selected is the first screen that the user, identified in the profile 402, will be directed to upon accessing the Internet and/or Intranet.

Another general setting can be a proxy 406 as well as proxy exception(s) 408. An administrator can specify an address for a proxy server, such as a server that provides Internet access to the computer. The proxy may also provide content-filtering services. Placing the proxy configuration in the user interface 400 prohibits user(s) from changing the proxy server setting.

Session timers 410 can be provided to log off the user after a predefined time. One timer is a setting that specifies how long a user can use the computer (e.g., 60 minutes). Once the time has expired, the user is automatically logged off. This is useful in situations where there are many users compared to a small number of machines available for use or during times when there is an increased amount of activity on the computers. Another timer is a setting that specifies how long a user can be idle or inactive before such user is automatically logged off (e.g., 2 minutes). Thus, if a user leaves the computer unattended (perhaps has left the area), the user does not remain logged on and the potential of other users stealing the logged on user's information is mitigated. Also provided can be a drive selection 412 that facilitates selecting drives to which the user is restricted.

Selecting or clicking in the box next to the lock this profile selection 414 prevents users from having the ability to change settings while logged on with the user account. This setting is useful in a shared computing environment where a plurality of users have access to the same machine. When the lock this profile 414 is selected, files that the operating system generally store for the user are not available when the next user logs on. This increases privacy while ensuring a clean, standardized desktop for the plurality of users of a shared computer. Examples of items that are not maintained between logons when lock this profile 414 is selected include Internet history and cookies, favorites, files stored on desktop, desktop wallpaper, changes to application settings, start menu changes, accessibility changes, etc. Also provided can be an optional restart check box 416 that forces the machine to restart when a user logs off of the selected profile.

Other settings can include recommended restrictions for shared accounts 416 that include important restrictions as well as the most used restrictions. These restrictions generally work together and having them in a category together allows ease of selecting the restrictions and further automates the process. Recommended restrictions 416 can include start menu restrictions 418, general operating system restrictions 420, Internet Explorer restriction(s) 422, word processing restrictions 424, and/or software restriction(s) 426. Each restriction can have a check box associated with it allowing an administrator and/or other authorized user to select that particular restriction. Each type of recommended restriction has a more (or expand) button (square with plus sign) that provides a drop-down menu of other actions associated with that particular restriction.

Expanding start menu restrictions 418 allows the administrator to select restrictions including disabling right-clicking in the start menu, forcing a classic start menu, hiding control panel, printer, and/or network settings, removing a plurality of icons to prevent a user from accessing those particular folders through an icon in the start menu, removing the shut down button, etc. Expanding general operating system restrictions 420 provides selection(s) for removing features (e.g., CD burning, folder options, search), disabling the recycle bin (ensures that later users cannot access the file through the recycle bin), preventing access to various commands (e.g. taskbar, command prompt, task manager, printer configuration, registry editor), preventing users from locking the workstation, preventing password changes, etc.

Some examples of Internet Explorer restrictions 422 include restricting menu choices (e.g., Internet options), restricting toolbar buttons. Examples of word processing restrictions 424 can include disabling various applications, disabling macro shortcut keys, tools, Web toolbar, etc. The software restrictions 426 can include policies for security settings that can restrict system tools and third-party software from running on the computer. For maximum security, all restrictions can be selected. Some of the restrictions include preventing software outside the Program Files and operating system folders from running, preventing default system tools from running (e.g., disk defragmenter, scandisk).

The administrator can select some or all of the restrictions in each drop down menu. For example, the administrator can restrict the user from accessing printers and/or faxes through the start menu while allowing the user to shut down or restart the computer through the icon on the Start menu. The administrator can make the selections on the drop down menu and on the main screen the administrator selects or checks the Start Menu restrictions 418 and only those restrictions selected in the drop-down list are restricted for the particular user and those unselected or unchecked would not be restricted.

Optional restrictions 428 can include additional restrictions to applications such as start menu, general operating system, Internet Explorer, software restrictions, etc. For example, additional restrictions can include preventing Internet access, preventing Internet Explorer from running, etc. These restrictions can be included in an optional restrictions 428 section because they might not be frequently used as restrictions. If there are other products on the machine for which restrictions should be applied, these can be added to the registry.

The user can exit the user interface 400 by accepting the user restrictions for the particular profile by selecting “Apply” 430 and/or “OK” 432. Apply 430 can be selected to apply the current restriction(s) to the selected user profile and continuing to apply restrictions to another user profile without exiting the user interface menu. If the user does not want to save the restrictions, the user can select “Cancel” 434” and the restrictions are removed and the user profile is reverted to its previous restriction(s), if any.

According to another embodiment, when at least two machines are to have the same restrictions applied, the first machine can push those restrictions to the other machine(s). In another embodiment, the other machines can pull the restrictions from the first machine. This mitigates the time spent by an administrator to implement the restrictions through a user interface on each machine.

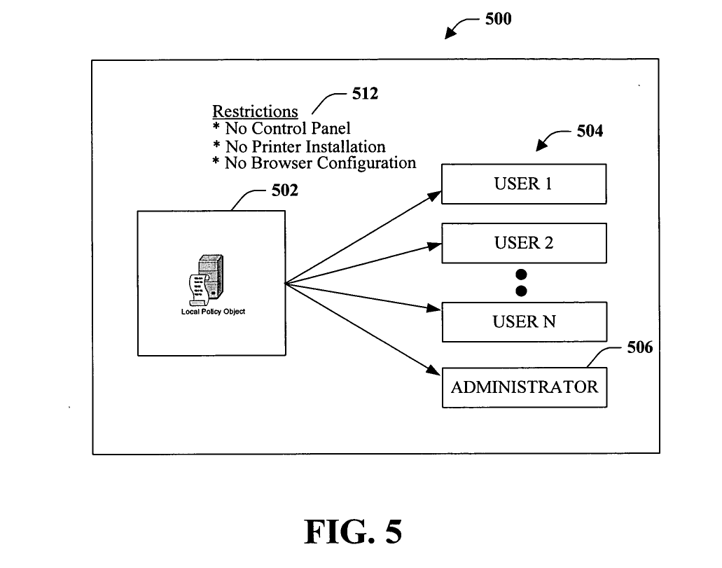

FIG. 5 illustrates an exemplary computer system 500 that does not utilize an active directory or the systems and/or methods disclosed herein. The computer system 500 can be a standalone computer(s) and/or a computer(s) in a distributed network environment. A local policy object 502 can be configured with a single set of local restrictions grouped in a single local policy. This single local policy is applied to a plurality of users 504 of the computer system 500 as well as to computer administrative account(s) 506. Thus, there is no distinction between the various systems users even if different user accounts and/or passwords are utilized to access the system.

There can be from one to N number of users, denoted User₁, User₂, . . . ,User_{N}, where N is an integer equal to or greater than one, referred to collectively as 504. Each user 504 can have a log on and/or password associating that user with a particular computer. The single local policy implemented by local policy object 502 can have the same restrictions for all users 504 and administrator user(s) 506.

For example, restrictions 512 can include prohibited functions such as no access to control panel, no ability to install printer(s), no ability to configure a browser. Once a single local policy object is defined, the restrictions are applied across the board regardless if the user is a child, an adult, an administrator, etc. Thus, without an active directory or a means to apply restrictions on a per-user basis, the users of the machine have the same restrictions. Thus, if the local policy object 502 is modified with the restriction that no printers can be installed, this restriction is applied not only to the user(s) 504 but also to the administrator 506. Thus, there is no means of selectively applying machine restrictions on a per-user basis.

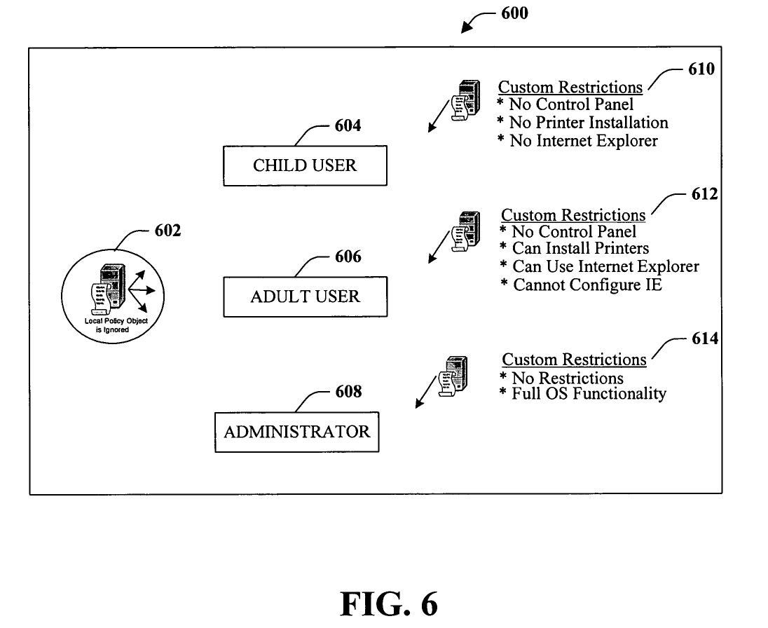

Referring now to FIG. 6, illustrated is a system 600 representation of multiple local user accounts associated with different user restrictions according to the systems and/or methods disclosed herein. The ability to associate user restrictions on a per-user or per group basis results in added computer functionality and enhanced manageability.

A computer system 600 may include a local policy object 602 that is applied to all users. If modifications are made for a specific user, the local policy object 602 is not used. As depicted, user(s) can be classified as child user(s) 604, adult user(s) 606, administrator(s) 608, etc. Depending on the user type, custom restrictions can be individually applied on a per-user basis when such user is associated with or logged onto the computer system 600.

By way of illustration and not limitation, a child user(s) 604 can have custom restrictions 610 that do not allow access to the control panel, no ability to install printer(s) and no access to the Internet, through, for example, Internet Explorer. Another user, denoted as adult user 606, has custom restrictions 612 tailored for such user. These restrictions 612 can include no access to control panel, the ability to install printers, the ability to use Internet Explorer, but not the ability to configure Internet Explorer. Another user can be an administrator 608 that has custom restrictions 614 tailored for such administrator 608. For example, administrator 608 can be given no restrictions and fully operating system functionality. It will be appreciated that the custom restrictions 610, 612, 614 depicted in FIG. 6 are for illustration purposes only and is not meant to be limiting. It should also be appreciated that while three users are shown, depicted as child user, adult user, and administrator, the disclosed systems and/or methods are not so limiting and a plurality of users and/or distinctions among the users is contemplated as falling within the scope of the subject disclosure and the appended claims.

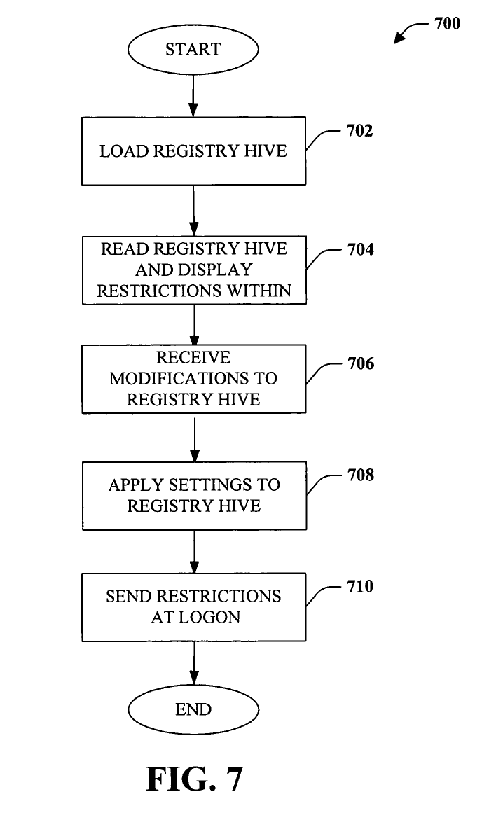

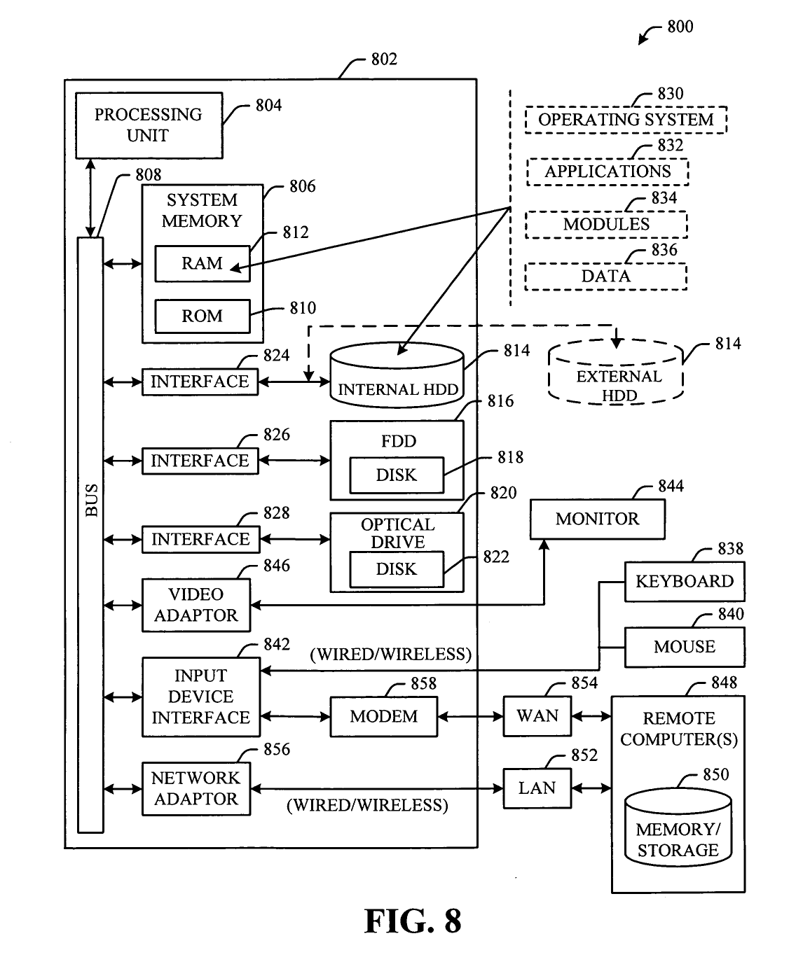

Referring now to FIGS. 7 and 8, methodologies relating to applying machine restrictions on a per-user basis are illustrated. While, for purposes of simplicity of explanation, the methodologies are shown and described as a series of acts, it is to be understood and appreciated that the methodologies are not limited by the order of acts, as some acts may, in accordance with these methodologies, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement the following methodologies.

Referring now to FIG. 7, illustrated is a flow chart of a methodology for configuring, modifying, and applying local machine restrictions. The methodology begins at 702 where a registry hive is loaded. The registry hive can be loaded utilizing a script. For example, the script to load a user's registry can be a function or routine and in the following exemplary function is referred to as

```
Function LoadUser (sUser)
  Dim sProfilePath
  LoadUser = False
  sProfilePath = “ “
  sProfilePath = GetProfilepath (sUser)
  If sProfilePath <> “” Then
    OShell.Run “REG LOAD HKEY_USERS\SSW “ & Chr (34) &
sProfilePath & “\ntuser.dat” & Chr(34), 0, True
    LoadUser = True
  End If
End Function
```

In the above function, “sProfilePath=GetProfilePath (sUser)” refers to the HKLM part of the registry and returns the path to the user profile for sUser. For example, this can be C:Documents and SettingsPublic. If the statement If sprofilepath <> “” is true, then the REG command is utilized to load the user's registry hive. It is to be understood that the above script is exemplary and is not intended to be limiting.

After the registry hive is loaded, a user and/or entity (e.g., the Internet, another system, a computer, . . . ) request to open the registry hive can be received. This request can be from an administrator and/or a user with the proper authentication to modify user profiles and configure parameters of a machine operating system. The administrator and/or authorized user can modify the registry hive through, for example, a user interface configured to facilitate setting of user restrictions though an interactive easy to use tool. Such a tool can provide a means to apply a plurality of restrictions for shared accounts. Examples of such restrictions include start menu restrictions, general operating system restrictions, Internet Explorer restrictions, word processing restrictions, software restrictions, etc. The user interface can also include session timers that automatically log off a user after a predetermined amount of use time or idle time has occurred. It is to be understood that other restrictions and/or settings can be utilized and fall within the scope of the subject disclosure and appended claims.

At substantially the same time as the request to open the registry hive is received, the registry hive is read, at 704, and the restrictions within the registry hive can be displayed on a screen, for example. Displaying the registry hive allows a user and/or entity to review the restrictions and determine whether such restrictions are appropriate or should be modified, deleted, and/or if other restrictions should be included.

The method continues at 706 when modifications to the restrictions are received through, for example, a user selecting an “Apply” and/or an “OK” selection on the user interface. The selected settings are applied to the registry hive, at 708, and at the next user log on or start up the settings are applied to the user. When the user, as defined by the user profile, logs onto the machine, the restrictions are applied or sent, at 710, though utilization of the user registry hive. The user is unable to change and/or alter the restrictions, which should be changed if necessary by an administrator and/or authorized user.

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various embodiments can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

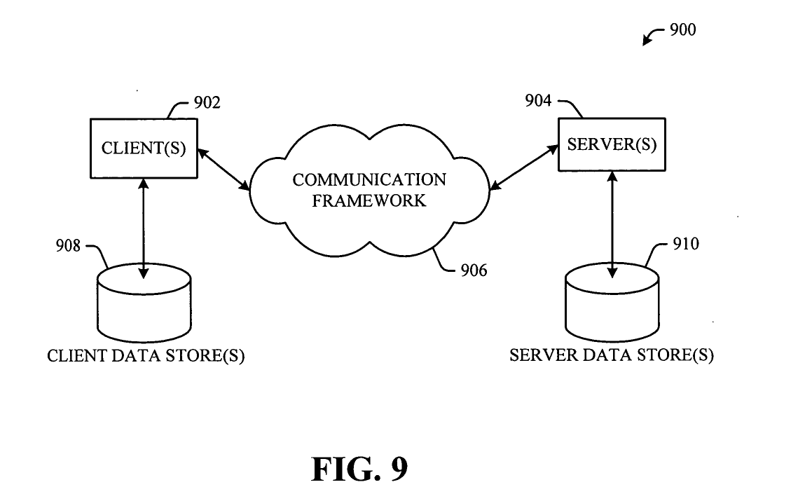

Referring now to FIG. 9, there is illustrated a schematic block diagram of an exemplary computing environment 900 in accordance with the various embodiments. The system 900 includes one or more client(s) 902. The client(s) 902 can be hardware and/or software (e.g., threads, processes, computing devices). The client(s) 902 can house cookie(s) and/or associated contextual information by employing the various embodiments, for example.

The system 900 also includes one or more server(s) 904. The server(s) 904 can also be hardware and/or software (e.g., threads, processes, computing devices). The servers 904 can house threads to perform transformations by employing the various embodiments, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system that facilitates per-user restrictions on a machine, comprising:
a component that receives at least one restriction modification for a machine and updates a profile with the at least one restriction modification; and
a component that receives the updated profile and modifies a profile registry hive.

2. The system of claim 1, the profile registry hive comprising registry information relating to an application setting.

3. The system of claim 2, the application setting comprising at least one of a desktop setting, an environment setting, a printer setting, and a network connection.

4. The system of claim 1, the profile represents a plurality of users that have access to the machine.

5. The system of claim 1, further comprising a script module that runs a script to load the profile registry hive.

6. The system of claim 1, the component that receives at least one restriction modification is an interface that automates applying one or more restrictions to the profile.

7. The system of claim 6, the interface further categorizes recommended restrictions for shared accounts.

8. The system of claim 6, further comprising a session timer that automatically logs off the machine after a predetermined time interval.

9. The system of claim 1, the machine is a shared computer accessed by a plurality of users.

10. The system of claim 1, the at least one restriction modification is a restriction to at least one of a start menu, an operating system, an Internet application, a word processing application, and a software application.

11. The system of claim 1, the machine does not use a directory service.

12. A method for applying local machine restrictions on a machine that does not use an active directory service, comprising:
configuring a registry hive associated with at least a first user;
modifying the registry hive for the at least a first user;
applying the modified registry hive to the at least a first user; and
restricting future access to the at least a first user based upon the modified registry hive.

13. The method of claim 12, modifying the registry hive for the at least a first user, further comprising:
providing a script that loads the registry hive; and
selecting parameters associated with the registry hive.

14. The method of claim 12, applying the modified registry hive to at least a first user is during a log on process.

15. The method of claim 12, further comprising:
accessing the registry hive through an interactive user interface; and
automating restriction settings through the user interface.

16. The method of claim 15, automating restriction settings further comprising:
grouping similar restrictions in a drop-down menu; and
selectively applying the restrictions to a selected profile.

17. The method of claim 12, further comprising:
applying a session timer that automatically logs off the at least a first user after a predefined period.

18. A system for applying local machine restrictions, comprising:
means for loading a registry hive of at least a first user;
means for modifying the registry hive; and
means for applying the modified registry hive to the at least a first user.

19. The system of claim 18, further comprising:
means for selectively applying the modified registry hive to a plurality of users; and
means for distinguishing among the plurality of users.

20. The system of claim 18, further comprising:
means for automating application of restrictions on a per-user basis; and
means for interfacing with an authorized user to facilitate configuration of the restrictions.
